(19) United States
(12) Patent Application Publication
(10) Pub. No.: US 2025/0362156 A1
(43) Pub. Date: Nov. 27, 2025

(54) METHOD FOR ACTIVATING A VEHICLE FUNCTION AND ASSOCIATED DEVICE

(71) Applicant: Continental Automotive Technologies GmbH, Hannover (DE)

(72) Inventors: Mohamed CHEIKH, Toulouse (FR); Alain BRILLON, VILLENEUVE TOLOSANE (FR)

(73) Assignee: Continental Automotive Technologies GmbH, Hannover (DE)

(21) Appl. No.: 19/108,360

(22) PCT Filed: Aug. 4, 2023
(86) PCT No.: PCT/EP2023/071715

§ 371 Date: Mar. 3, 2025

(30) Foreign Application Priority Data
Sep. 27, 2022 (FR) FR2209760

(51) Int. Cl. G01D 5/14; B60R 25/24

(52) U.S. Cl. CPC G01D 5/14; B60R 25/245

(57) ABSTRACT

A method for activating a vehicle function, by an activation device, from a “hands-free” access device carried by a user and provided with a magnetometer. The activation of the function being triggered by detecting the presence of the device in a predetermined zone around the vehicle or in a passenger compartment of the vehicle, and according to an authentication result of the device, the device including at least one external transceiver able to transmit outside the vehicle and one internal transceiver able to transmit in the passenger compartment of the vehicle. The method including: detecting the presence of the device in a predetermined zone; the access device continuously measuring an amplitude of the magnetic field and an orientation of the magnetic field; comparing the measurements with predetermined amplitude and orientation profiles; activating a vehicle function according to the result of the comparisons.

### CROSS REFERENCE TO RELATED APPLICATIONS

This application is the U.S. National Phase Application of PCT International Application No. PCT/EP2023/071715, filed Aug. 4, 2023, which claims priority to French Patent Application No. 2209760, filed Sep. 27, 2022, the contents of such applications being incorporated by reference herein.

### FIELD OF THE INVENTION

The invention relates to a method for activating a function of a motor vehicle and an associated activation device. The invention particularly, but in a by no means limiting manner, applies to the function of hands-free access to a motor vehicle, i.e. to the function of locking and unlocking the opening elements of a motor vehicle.

### BACKGROUND OF THE INVENTION

In a motor vehicle, it is known practice to use vehicle function activation devices that are able to detect the presence of a hand or a foot of a user of the vehicle and thus allow all or some of the opening elements of the vehicle, for example the doors or the trunk, to be locked or unlocked. By way of an example, detecting the presence of a hand of a user on or in front of a door handle in conjunction with the recognition of an identifier of a “hands-free” access device carried by the user allows these opening elements to be locked and unlocked.

A “hands-free” access system for accessing a motor vehicle allows an authorized user to lock and/or unlock the opening elements of their vehicle without having to physically press buttons on a key. For this purpose, the vehicle identifies a portable device such as a fob or a remote control or even a key carried by the user and, if the fob or the remote control or indeed the key is located in a predetermined zone around the vehicle or in the vehicle and is identified as belonging to the vehicle, then the vehicle automatically locks/unlocks its opening elements according to the intention of the user, without the user having to physically manipulate a key.

To this end, when the user approaches the vehicle, a communication is established over a wireless communication link between the “hands-free” access device, for example an electronic fob or a smartphone, and the vehicle function activation device in order to authenticate said access device by virtue of its identifier.

To this end, the activation device comprises at least one radiofrequency antenna allowing the identifier sent by the “hands-free” access device to be received. The activation device is connected to an electronic computer or ECU (Electronic Control Unit) of the vehicle, to which unit it transmits the identifier.

According to the prior art, the access device is generally an electronic fob. The signal received by the antenna of the activation device, containing the identifier of the access device, is sent via RF (RadioFrequency) or LF (Low Frequency) waves. The precise location of the portable device around the vehicle is determined by measuring the strength of the LF signal received by the portable device (via the antennas and the electronic control unit) from the vehicle, which strength measurements are more commonly called RSSI (Received Signal Strength Indicator) measurements. The measurement of the strength of each signal received by the portable device from each antenna of the plurality of LF antennas located in the vehicle V is received and analyzed by an activation device on board the vehicle, which thus determines, via triangulation, the position of the portable device with respect to said LF antennas, i.e. with respect to the vehicle.

Depending on the location of the portable device identified by the vehicle, in said location zones, some actions specific to said location zones are automatically carried out, namely unlocking/locking or turning on welcome lighting in the passenger compartment in advance.

Nowadays, however, it is increasingly common to use a cell phone to perform authentication functions, which avoids having to use a dedicated electronic fob and thus limits the number of devices. Most cell phones do not possess RF or LF communication means. Therefore, the “hands-free” start-up and/or access system for a vehicle needs to be adapted in order for it to also be able to function with a cell phone equipped with other communication standards, such as, for example, ultra-wideband, or BLE (Bluetooth Low Energy®), or Wi-Fi (Wireless Fidelity) communication and no longer only using radiofrequency and low-frequency (RF and LF) waves. Ultra-wideband (UWB), in particular, is a radio modulation technique that is based on transmitting pulses with a very short duration, often less than a nanosecond. Thus, the bandwidth can reach very high values.

When the access device approaches the vicinity (less than 2 m away from) of the activation device and recognizes the identifier received by the computer, in conjunction with detecting the presence of the hand of the user, this allows the door to be locked or unlocked.

The disadvantage of using UWB communication means is the location precision of the access device (cell phone or fob), which is worse compared to the use of low-frequency 125 kHz communication means of the prior art.

Indeed, ultra-wideband is more sensitive to reflections and interference. Thus, precise location involves providing the vehicle with between six and eight UWB transceivers (four to six on the outside of the vehicle and two inside the vehicle), so that three UWB transceivers are always visible to the access device, whereas at low frequency, according to the prior art, a single visible transceiver can precisely locate the access device, and the vehicle is generally provided with three external antennas and 2 internal antennas for the same location precision.

The result of this increase in the number of UWB transceivers on the vehicle is an undesirable additional cost for the activation device.

### SUMMARY OF THE INVENTION

An aspect of the invention proposes a method and a device for activating a vehicle function that overcomes the disadvantages of the prior art, in this case not generating additional costs for the activation device.

An aspect of the invention relates to a method for activating a vehicle function, by means of an activation device, from a “hands-free” access device carried by a user and provided with a magnetometer, with the activation of the function being triggered by detecting the presence of the device in a predetermined zone around the vehicle or in a passenger compartment of the vehicle, and according to an authentication result of the device, the activation device comprising at least one external radiofrequency transceiver able to transmit outside the vehicle and one internal radiofrequency transceiver able to transmit in the passenger compartment (Z0) of the vehicle, the method being noteworthy in that it comprises the following steps of:
a. detecting the presence of the device in a predetermined zone by means of radiofrequency communication;
b. the access device continuously measuring an amplitude of the magnetic field and an orientation of said magnetic field;
c. comparing said measurements with predetermined amplitude and orientation profiles;
d. activating a vehicle function according to the result of said comparisons.

In one embodiment, the measurements are sent to the vehicle by means of radiofrequency communication, and the comparison is carried out by the vehicle.

In another embodiment, the comparison is carried out by the portable device and the result of the comparison is sent to the vehicle by means of radiofrequency communication.

The radiofrequency communication can involve high or ultra-high frequency communication.

In an improvement to an aspect of the invention, the access device is provided with an accelerometer, the measurements of the magnetic field are corrected by scalar product with measurements originating from the accelerometer and said scalar product is compared with a predetermined scalar product profile, with the vehicle function being activated according to the result of the comparison.

An aspect of the invention also relates to a “hands-free” access device for accessing a motor vehicle, with said device being carried by a user and provided with a magnetometer and being able to communicate with the vehicle by means of radiofrequency communication, the access device being noteworthy in that it is able to:
a. continuously measure an amplitude of the magnetic field and an orientation of said magnetic field;
b. compare said measurements with predetermined amplitude and orientation profiles;
c. activate the vehicle function according to the result of the comparisons.

In one embodiment, the access device is able to:
a. continuously measure an amplitude of the magnetic field and an orientation of said magnetic field;
b. send said measurements to the vehicle.

In an improvement to an aspect of the invention, the “hands-free” access device for accessing a motor vehicle comprises an accelerometer (ACC), said device is also able to:
a. continuously measure acceleration values;
b. correct the measurements of the magnetometer with the measurements of the accelerometer by scalar product;
c. compare the values of the scalar product with a predetermined scalar product profile;
d. activate the vehicle function according to the result of the comparison.

In another embodiment of the improvement to the invention, said device comprises an accelerometer that is also able to:
a. continuously measure acceleration values;
b. send said measurements to the vehicle.

An aspect of the invention also relates to any activation device for activating a vehicle function, with the activation of the function being triggered by detecting the presence of a “hands-free” access device carried by a user in a predetermined zone around the vehicle or in a passenger compartment of the vehicle, and according to an authentication result of said device, with the activation device comprising at least one external antenna module for transmitting/receiving radiofrequencies and one internal antenna for transmitting/receiving radiofrequencies able to transmit in the passenger compartment of the vehicle, said device communicating with the “hands-free” access device, and being noteworthy in that it is able to:
a. receive measurements of the amplitude of the magnetic field and of the orientation of the magnetic field originating from said device;
b. compare said measurements with predetermined amplitude and orientation profiles;
c. activate a vehicle function according to the result of the comparisons.

In an improvement to an aspect of the invention, the device is able to:
a. receive measurements of the amplitude of the magnetic field and of the orientation of the magnetic field and of acceleration originating from said device;
b. correct the values of the magnetometer with the values of the accelerometer by scalar product;
c. compare the values of the scalar product with a predetermined scalar product profile;
d. activate the vehicle function according to the result of said comparison.

An aspect of the invention applies to any computer program product comprising program code instructions for executing the steps of the method according to any one of the features listed above when said program is executed on a computer.

Finally, an aspect of the invention relates to any motor vehicle comprising an activation device according to any one of the aforementioned features.

### BRIEF DESCRIPTION OF THE DRAWINGS

Further features and advantages of aspects of the invention will become more clearly apparent upon reading the following description. This is purely illustrative and must be read with reference to the appended drawings, in which:

FIG. 1 schematically shows a motor vehicle comprising an activation device according to an aspect of the invention;

FIG. 2 schematically shows a hands-free access device according to a first embodiment of the invention;

FIG. 3 schematically shows an activation device according to a second embodiment of the invention;

FIG. 4 is a flowchart illustrating the activation method according to an aspect of the invention;

FIG. 5 is a graph showing the amplitude variation of the magnetic field measured by the access device according to the distance between said device and the vehicle;

FIG. 6 is a graph showing the orientation variation of the magnetic field vector measured by the access device according to the distance between said device and the vehicle;

FIG. 7 schematically shows the rotation of the vector of the magnetic field measured by the access device when the user carrying said device approaches the vehicle and then enters the interior of said vehicle;

FIG. 8 is a graph showing the variation of the scalar product between the magnetic field vector and the acceleration vector according to the time when the user carrying the access device approaches the vehicle and then enters the passenger compartment.

### DETAILED DESCRIPTION OF EXEMPLARY EMBODIMENTS

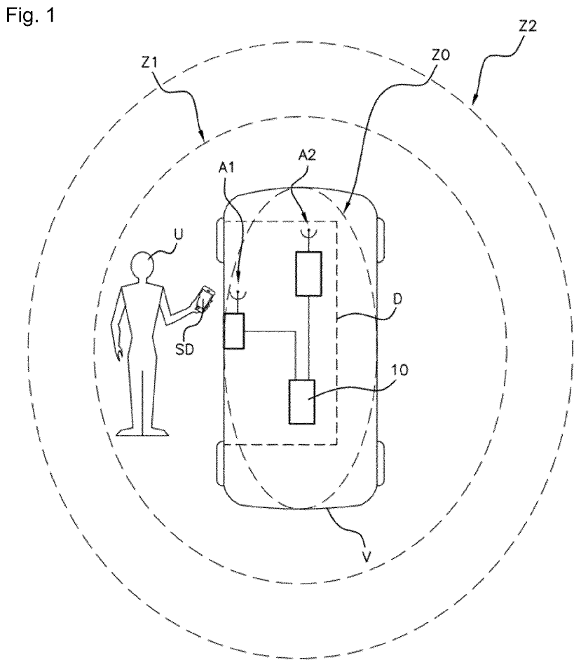

FIG. 1 shows a motor vehicle V comprising an activation device D for activating a vehicle function according to an aspect of the invention.

A vehicle function not only refers to the functions such as locking or unlocking the opening elements (doors or trunk) of the vehicle, but also to functions for turning on some of the lighting of the vehicle when the user approaches, also called “welcome lighting”, or even for pre-adjusting the seat of the driver, etc.

These functions are activated when the user U is detected in a predetermined zone Z1 (see FIG. 1) around the vehicle and has been previously identified as being authorized to access the vehicle V.

A vehicle function also can be the “hands-free” start-up of the vehicle V, in this case, the activation device D will have previously precisely located the access device in the passenger compartment Z0 of the vehicle V.

More specifically, the “hands-free” access device SD carried by the user, for example a smartphone, communicates with the activation device D by means of radiofrequency waves, for example high or ultra-high-frequency waves, such as ultra-wide band, Wi-Fi, BLE or the like, in order to exchange its identifier therewith. The activation device D, for its part, determines the position of the device SD with respect to the vehicle V and verifies its identifier. This method for “hands-free” access to a vehicle V is known in the prior art and will not be described in further detail herein.

To this end, the activation device D comprises at least two transceivers, a radiofrequency transceiver A1 able to transmit outside the vehicle in order to activate the unlocking/locking functions or other functions that can be activated as the user approaches (pre-heating of the seats, pre-adjustments of the radio, seats, etc.), and an internal radiofrequency transceiver A2 able to transmit in the passenger compartment Z0 of the vehicle in order to activate the hands-free start-up function of the vehicle V.

The two transceivers A1, A2 are electronically connected to a central control unit 10, which itself is connected to the function activation means, i.e. the door unlocking/locking mechanisms or the mechanism for starting the vehicle V or any other mechanism activating a function.

The central control unit 10 comprises means for processing the information received by the transceivers that allow it to activate or not activate the vehicle functions. This is known to a person skilled in the art.

The central control unit 10 also comprises a processor 100 and a memory 101 (see FIG. 3) that records instructions allowing the processor to be configured to execute certain particular processing operations, and notably to implement the steps of the opening/closing method, according to the embodiment described hereafter.

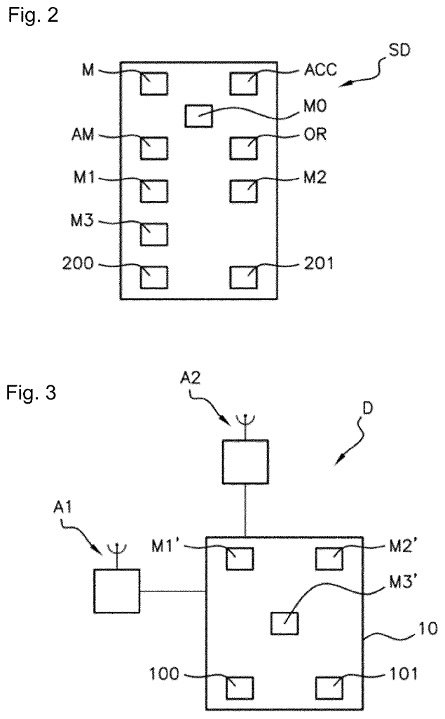

The “hands-free” access device SD carried by the user is provided with a magnetometer M (see FIG. 2), which measures the amplitude and the orientation of the Earth's magnetic field.

Of course, said device SD is able to communicate by means of radiofrequencies (high or ultra-high frequency) with the vehicle V via the transceivers A1, A2. To this end, it is provided with suitable communication means (not shown in FIG. 2) and can send and receive data.

The access device SD also comprises a processor 200 and a memory 201 (see FIG. 3) that records instructions allowing the processor to be configured to execute certain particular processing operations, in particular to implement the steps of the opening/closing method, according to the embodiment described hereafter.

In a first embodiment of the invention, the “hands-free” access device SD is also able to:
a. continuously measure an amplitude AM, also called norm, of the magnetic field vector and an orientation OR according to the three spatial dimensions of said magnetic field;
b. compare said measurements AM, OR with predetermined amplitude AMD and orientation ORD profiles;
c. activate the vehicle function according to the result of the comparison.

The amplitude or the norm AM of the magnetic field is provided by the following equation:

$$[ Math 1 ]$$

$$AM = ‖ \vec{r} ‖ = \sqrt{{AMx}^{2} + {AMy}^{2} + {AMz}^{2}}$$

With:
\vec{r}: being the vector of the Earth's magnetic field perceived by the portable device.
AMx: being the amplitude of the magnetic field measured along the x-axis.
AMy: being the amplitude of the magnetic field measured along the y-axis.
AMz: being the amplitude of the magnetic field along the z-axis.

The orientation OR of the magnetic field corresponds to the angular coordinates of the magnetic field vector \vec{r} in the three planes (XY, YZ, ZX) of a Cartesian coordinate system (0, x, y, z) and that are provided by the three angles θ, φ and α, that is:

$$[ Math 2 ]$$

$$\vec{OR} = \vec{r} ( θ , φ , α )$$

With:
α: being the angle of the vector r on the XY plane.
β: being the angle of the vector r on the YZ plane.
φ: being the angle of the vector r on the ZX plane.

This is illustrated in FIG. 6. The top of FIG. 6 illustrates a Cartesian coordinate system (0, x, y, z). The magnetic field vector \vec{r} is shown therein, as well as the amplitudes of said field AMx, AMy, AMz on the three axes x, y, z, as well as the angles α, β, α formed by the magnetic field vector with each of the three planes XY, YZ, and ZX of the coordinate system.

To this end, the portable access device SD comprises (see FIG. 2):
a. means M0 for recording the amplitude AM and the orientation OR of the magnetic field measured by the magnetometer M according to the time t;
b. comparison means M1, M2 for comparing each of the profiles thus recorded with a predetermined profile AMD, ORD;
c. means M3 for activating the vehicle function according to the result of the two comparisons.

The comparison means M1, M2 can be made up of software means.

The activation means M3 can include an instruction sent to the activation device D, which triggers the one or more corresponding functions on the vehicle V.

In this first embodiment, the activation device D therefore receives an instruction to activate a vehicle function from the access device SD, which has previously processed the amplitude AM and orientation OR measurements of the magnetic field and has determined whether the access device SD was correctly located in a predetermined zone Z1 around the vehicle V, or in the passenger compartment Z0, in which zones corresponding vehicle functions can be activated.

In a second embodiment of the invention, the access device SD continuously measures the amplitude AM and orientation OR values of the magnetic field and sends said measurements to the activation device D. In this second embodiment, the access device SD only comprises means M0 for recording said values.

In this second embodiment, the activation device D, for its part, is able to:
a. receive measurements of the amplitude AM of the magnetic field and of the orientation OR of the magnetic field originating from said device SD;
b. compare said measurements AM, OR with predetermined amplitude AMD and orientation ORD profiles;
c. activate a vehicle function according to the result of the comparison.

To this end, in order to implement this second embodiment, the activation device D comprises:
a. means M1′, M2′ for comparing the recorded amplitude AM and orientation OR values according to time t, with predetermined amplitude AMD and orientation ORD profiles;
b. means M3′ for activating a vehicle function according to the result of the two comparisons.

The comparison means M1′, M2′ can be made up of software means.

The activation means M3′ are connected to the various mechanisms present on the vehicle V for switching on said functions.

In an improvement to an aspect of the invention, the access device SD comprises an accelerometer ACC, and the measurements from the magnetometer AM, OR are corrected by virtue of the values of the accelerometer ACC. This is described below.

In a first improvement to an aspect of the invention, the access device SD is also able to:
a. continuously measure acceleration values ACC;
b. correct the measurements of the magnetometer M with the measurements of the accelerometer ACC by scalar product;
c. compare the values of the scalar product PSC with a predetermined scalar product profile PSC_{D};
d. activate the vehicle function according to the result of the comparison.

To this end, the access device SD comprises:
a. means for measuring and recording the values of the accelerometer ACC;
b. means for scalar product multiplication of the values of the magnetometer M with the values of the accelerometer ACC;
c. means for comparing between the values of the scalar product PSC over time and a predetermined scalar product profile PSC_{D};
d. means for activating a vehicle function F1, F2 according to the result of said comparison.

The aforementioned means (not shown in the figures) can be made up of software means.

In a second improvement to an aspect of the invention, the access device SD is able to:
a. continuously measure acceleration values ACC;
b. send said measurements to the vehicle V.

In this second improvement to an aspect of the invention, the vehicle V receives all the measured values of the magnetometer M and the accelerometer ACC originating from the access device SD and the activation device D is then able to:
a. receive measurements of the amplitude AM of the magnetic field and of the orientation OR of the magnetic field and measurements of acceleration ACC originating from said device SD;
b. correct the values of the magnetometer M with the values of the accelerometer ACC by scalar product;
c. compare the values of the scalar product PSC with a predetermined scalar product profile PSC_{D};
d. activate the vehicle function F1, F2 according to the result of said comparison.

To this end, the activation device D then comprises:
a. means for scalar product multiplication of the values of the magnetometer M with the values of the accelerometer ACC;
b. means for comparing between the values of the scalar product PSC over time and a predetermined scalar product profile PSC_{D};
c. means for activating a vehicle function F1, F2 according to the result of said comparison.

The aforementioned means (not shown in the figures) can be made up of software means.

As previously specified, with the activation device D being able to exchange data with the access device SD by means of radiofrequency communication, it is able to receive the data originating from the magnetometer M and from the accelerometer ACC.

Scalar product is understood to mean the scalar product, per unit of time, of a value of the magnetometer M at a given instant by a value of the accelerometer at the same instant. It is essential, in order for an aspect of the invention to be implemented correctly, that the values originating from the magnetometer and the accelerometer that are multiplied by scalar product are synchronized, i.e. they have been measured at the same instant.

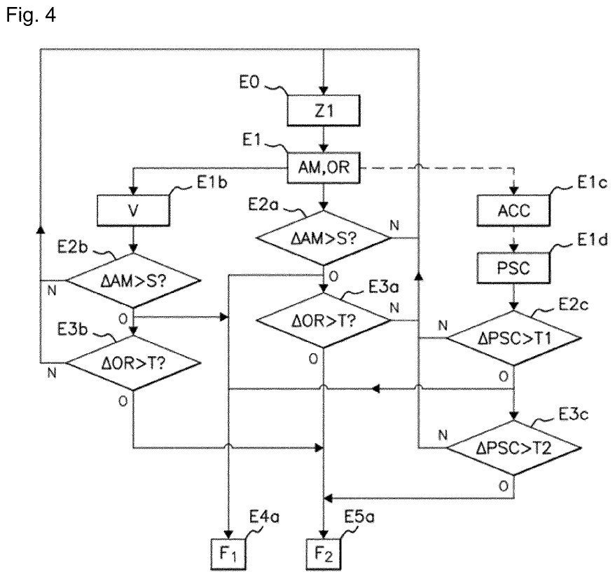

The activation method illustrated in FIG. 4 will now be described.

In a preliminary step (E0), the “hands-free” access device is detected in a predetermined zone around the vehicle V, this zone can be a remote zone Z2 located around the vehicle (see FIG. 1). During this step, the access device SD and the vehicle V communicate with each other by means of high or ultra-high frequency communication, the access device is authenticated and its relative position with respect to the vehicle V is determined. This preliminary step then allows the recording of the measurements originating from the magnetometer M (step E1) to be triggered.

It should be noted that this step is optional, indeed, the portable device SD could continuously record the data originating from its magnetometer M; however, this solution appears to be energy-intensive, and it seems more reasonable to only trigger this recording when the access device SD has been detected around the vehicle V, in a remote zone Z2 and consequently when the user may wish to activate a vehicle function.

During a first step E1, the access device SD records the amplitude AM and orientation OR measurements of its integrated magnetometer M per unit of time (for example, ms) and for a predetermined duration At, for example 0.5 s, with a sampling frequency of 50 Hz, i.e. one measurement taken every 20 ms over the duration of 0.5 s.

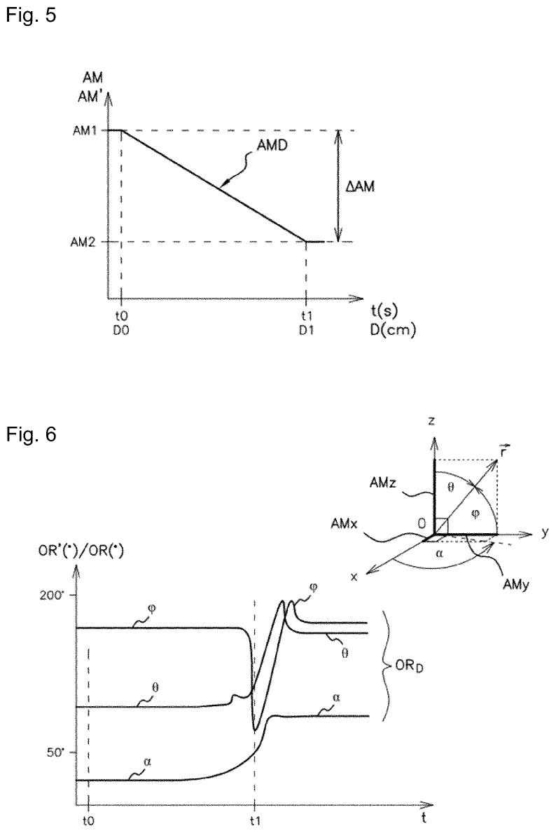

During a second step, the profile of the amplitude AM measurements is compared with a predetermined profile AMD (see FIG. 5).

More specifically, a check is carried out to determine whether the value of the amplitude decreases over time, and if this decrease is above a threshold.

This is illustrated in FIG. 5. In FIG. 5, the amplitude value AM at the initial instant t0 for starting recording has a first value AM1, then at a first instant t1, after a few milliseconds or seconds, this value has decreased to reach a second value AM2. If the difference AAM between the two values AM1, AM2 is greater than a predetermined threshold S, for example equal to S=70%, then the access device SD is considered to be approaching the vehicle V (step E2a).

Indeed, the applicant has found that the predominantly metal bodywork of the vehicle disrupted the values of the Earth's magnetic field perceived by the magnetometer M integrated in the access device SD.

In this case, when the access device SD approaches the vehicle, the amplitude value AM of the Earth's magnetic field measured by the magnetometer integrated with said device decreases considerably.

Of course, this decrease originates from the metal interference of the vehicle bodywork and not a local anomaly in the Earth's magnetic field.

Therefore, by measuring this variation in the amplitude of the magnetic field, it is thus possible to detect the approach of the access device SD toward the vehicle V and that it is located in the predetermined zone Z1.

If the access device SD approaches the vehicle V in such a way that it is located in the predetermined zone Z1, then a vehicle function F1, such as, for example, unlocking the door, can be activated (step E4a). The user is considered to be located in the zone Z1, when, for example, the amplitude variation AAM exceeds a threshold, for example, of more than 70%. This indicates a 70% decrease in the amplitude value AM over a predetermined duration Δt (for example, between the initial instant to and the first instant t1).

The amplitude variation allows the distance of the device SD with respect to the vehicle V to be determined, this was previously measured in a calibration phase, where a lookup table between amplitude and distance variation was established.

In a subsequent step, the measurement profile of the orientation OR of the magnetic field is compared with a predetermined profile OR_{D} (step E3a). More specifically, it is the orientation of the magnetic field vector \vec{r}.

The magnetometer M measures the orientation of the magnetic field M in the three cardinal directions x, y, z (see FIG. 6), of an orthogonal coordinate system and deduces the orientation of the magnetic field vector therefrom.

This is illustrated in FIG. 6. FIG. 6 shows the measurements of the three orientation angles of the magnetic field vector θ, φ and α according to time t.

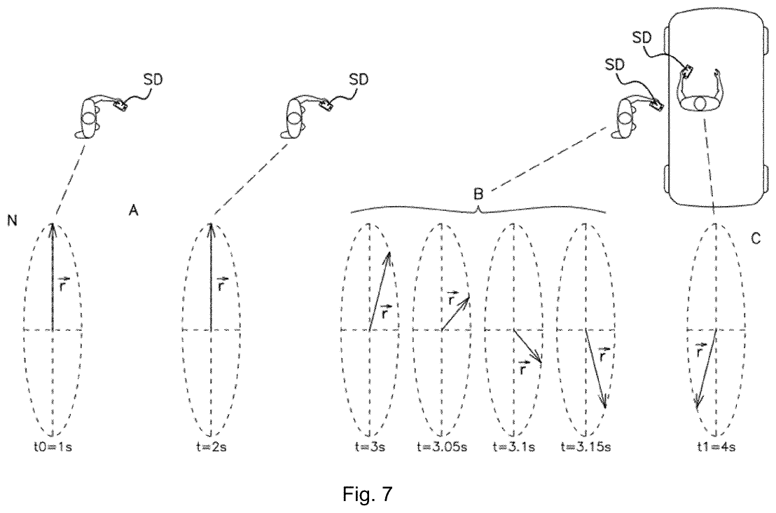

At the initial instant t0 for starting recording, the values of the angles are separated from each other, and are stable, with the angle value φ being greater than the angle value θ, which itself is greater than the angle value α. In this configuration, the magnetic field vector \vec{r} points towards the Earth's magnetic north, as illustrated in FIG. 7.

The user U carrying the access device SD is located around the vehicle V, illustrated by the letter “A” in FIG. 7.

Then, at the instant t1, there is a sudden change in the values of the three angles, with the value of the angle θ decreasing and the value of the angle α increasing, both considerably. The values of said two angles intersect. The value of the angle α, for its part, substantially increases.

This intersection between the values of the angles θ and φ corresponds to a rotation of the magnetic field vector \vec{r}.

This is illustrated in FIG. 7, when the access device SD approaches the vehicle V, identified by the letter “B” in FIG. 7, the metal bodywork of the vehicle V disrupts the measurement of the orientation of the magnetic field and the magnetic field vector measured by the magnetometer M rotates on itself. When the user carrying the access device SD enters the vehicle, the immediate proximity of the metal of the bodywork results in the almost total rotation of the magnetic field vector, this is illustrated by the letter “C” in FIG. 7.

Similarly, this rotation of the magnetic field vector is “artificial” because it is generated by the metal of the car, which falsifies the measurements of the magnetometer M.

According to an aspect of the invention, this rotation of the magnetic field means that it is possible to detect that the user carrying the access device enters inside the vehicle V. In order for the rotation to be detected, the variation in orientation AOR, as an absolute value, for each of at least two of the three angles, for example θ and φ (as illustrated in FIG. 6), needs to be greater than a threshold T, for example of 45° for a predetermined duration, for example between the initial instant t0 and the instant t1.

Once the user U is in the vehicle, the rotation attenuates and becomes slower because the environment in the passenger compartment of the vehicle V is not magnetically stable. The rotation stops once the portable device SD is placed in the passenger compartment. In other words, the magnetic field vector has changed direction with respect to its direction when the user was far away from the vehicle V.

Indeed, the angle values of the magnetic field vector are each stable once again, yet they are different values and are ordered differently from each other.

Thus, the value of the angle θ is greater than the value of the angle φ, which itself is greater than the angle value α.

The user U is then considered to be located in the passenger compartment Z0 and that secure vehicle functions F2, such as starting the vehicle, can be activated (step E5a).

In this first embodiment, when the amplitude and orientation profiles correspond to the detection of the user U in a predetermined zone or the activation of a function is possible, the access device sends an instruction to the activation device D to activate the corresponding function.

In a second embodiment, shown by the left-hand branch of the flowchart, once recording of the amplitude AM and orientation OR measurements of the magnetic field has begun (step E1), said measurements are sent to the vehicle (step E1b) by the access device SD continuously or in blocks of measurements.

The vehicle V, more specifically the activation device D, then compares (step E2b, step E3b) the profiles of the amplitude AM and orientation OR measurements of the magnetic field with the predetermined profiles, as explained above for detecting either the approach of the user U to the vehicle in the predetermined zone Z1 and for activating the approach F1 functions (step E4a), or the user entering the passenger compartment and their location in the passenger compartment Z0 of the vehicle and activating the vehicle start-up functions F2 (step E5a).

In this second embodiment of the activation method according to the invention, the activation device D processes the data originating from the access device SD.

In an improvement to the activation method according to an aspect of the invention, the access device SD is provided with an accelerometer ACC (see FIG. 2). This improvement is illustrated by the right-hand branch of the method in FIG. 4.

In this embodiment, the measurements originating from the magnetometer M are corrected by the measurements originating from the accelerometer ACC (step E1c). Indeed, the measurements of the Earth's magnetic field can be disrupted by the acceleration experienced by the access device SD in the three spatial dimensions. These disruptions may make approach detection in the zone Z1 or the location of the user in the passenger compartment Z0 less precise when carried out solely based on the measurements of the magnetometer M.

The method proposes determining the scalar product PSC between the magnetic field vector and the accelerometer vector (step E1d) and only using the values of the scalar product PSC in order to detect the approach of the access device to the vehicle V, or said device entering the passenger compartment, according to the following formula:

$$[ Math 3 ]$$

$$PSC = \vec{r} [ \begin{matrix}AMx \\ AMy \\ AMz\end{matrix} ] \cdot \vec{ACC} [ \begin{matrix}Accx \\ Accy \\ Accz\end{matrix} ] and$$

$$[ Math 4 ]$$

$$PSC = ‖ \vec{r} ‖ \times ‖ \vec{ACC} ‖ \times cos ( ω )$$

With:
AMx: being the amplitude of the magnetic field along the x-axis.
AMy: being the amplitude of the magnetic field along the y-axis.
AMz: being the amplitude of the magnetic field along the z-axis.
Accx: being the amplitude of the acceleration along the x-axis.
Accy: being the amplitude of the acceleration along the y-axis.
Accz: being the amplitude of the acceleration along the z-axis.
ω: being the angle between the magnetic field vector \vec{r} and the acceleration vector \vec{ACC}.
∥\vec{r}∥: being the absolute value of the amplitude or norm of the magnetic field vector.
   |\vec{ACC}|: being the absolute value of the amplitude or norm of the acceleration vector.

The resulting scalar product PSC is then compared with a predetermined scalar product profile PSC_{D}.

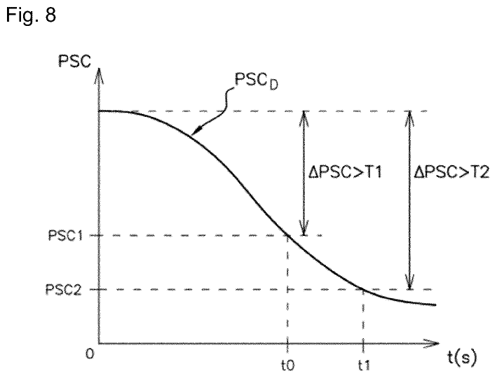

This is illustrated in FIG. 8. FIG. 8 illustrates the scalar product PSC between the magnetic field vector \vec{r} and the acceleration vector \vec{ACC} according to time t.

Up to the instant t0, the user carrying the access device SD approaches the vehicle V, which has the effect of decreasing the value of the scalar product PSC to a first value PSC1.

If the decrease in the scalar product value ΔPSC is greater than a first threshold T1 equal, for example, to 50%, then the access device SD is considered to be located in the predetermined zone Z1 around the vehicle V (step E2c) and the vehicle function F1 corresponding to the approach can be activated (step E4a).

Between the instants to and t1, the user enters the vehicle V, the value of the scalar product PSC continues to decrease until it reaches a second threshold value PSC2.

If the decrease in the scalar product value ΔPSC is greater than a second threshold T2 equal, for example, to 70%, and occurs within a predetermined time window, in this case between the instants to and t1, then the access device SD is considered to be located in the predetermined zone Z0 of the vehicle V (step E3c) and the vehicle function F2 corresponding to the detection of said device SD in the passenger compartment can be activated (step E5a).

This improvement to an aspect of the invention means that it is possible to achieve better precision in terms of the location of the portable device SD, because the movements of the access device SD are thus correlated with the variations in the magnetic field perceived by the magnetometer M.

As specified above, it is nevertheless essential that the measurements originating from the magnetometer M and the accelerometer ACC, which are multiplied together by scalar product, have been measured at the same instant.

Thus, according to an aspect of the invention, the variations in the Earth's magnetic field perceived by the magnetometer M integrated in the portable access device SD are sufficient for determining the position of the user in predetermined zones and for activating corresponding vehicle functions.

An aspect of the invention is particularly ingenious because it dispenses with, unlike the prior art, a plurality of transceivers located all around and inside the vehicle.

Indeed, according to an aspect of the invention, only at least two radiofrequency transceivers are required to activate all the functions related to the user approaching the vehicle and/or their presence in the passenger compartment.

The invention therefore has the advantages of being relatively inexpensive, easy to implement and reliable, thus avoiding the disadvantages of the prior art.

1. A method for activating a vehicle function, by an activation device, from a “hands-free” access device carried by a user and provided with a magnetometer, with the activation of the function being triggered by detecting the presence of the device in a predetermined zone around the vehicle or in a passenger compartment of the vehicle, and according to an authentication result of the device, the activation device comprising at least one external radiofrequency transceiver able to transmit outside the vehicle and one internal radiofrequency transceiver able to transmit in the passenger compartment of the vehicle, the method being characterized in that it comprises the following steps of:
a) detecting the presence of the device in a predetermined zone by of radiofrequency communication;
b) the access device continuously measuring an amplitude of the magnetic field and an orientation of said magnetic field;
c) comparing said measurements with predetermined amplitude and orientation profiles:
i) if the amplitude of the magnetic field drops over time and said amplitude drop is greater than a threshold over a predetermined duration; or
ii) if a variation in the orientation of the magnetic field for a predetermined duration corresponds to a rotation;
d) then, activating a vehicle function according to the result of said comparisons.

2. The activation method as claimed in claim 1, wherein the measurements are sent to the vehicle by radiofrequency communication, and the comparison is carried out by the vehicle.

3. The activation method as claimed in claim 1, wherein the comparison is carried out by the portable device and the result of the comparison is sent to the vehicle by radiofrequency communication.

4. The method for activating a vehicle function as claimed in claim 1, wherein the radiofrequency communication can involve high or ultra-high frequency communication.

5. The method for activating a vehicle function as claimed in claim 1, wherein the access device is provided with an accelerometer, the measurements of the magnetic field are corrected by scalar product with measurements originating from the accelerometer and said scalar product is compared with a predetermined scalar product profile, with the vehicle function being activated according to the result of the comparison.

6. A “hands-free” access device for accessing a motor vehicle, with said device being carried by a user and provided with a magnetometer and being able to communicate with the vehicle by radiofrequency communication, the access device adapted to:
a) continuously measure an amplitude of the magnetic field and an orientation of said magnetic field;
b) compare said measurements with predetermined amplitude and orientation profiles; and
c) activate the vehicle function according to the result of the comparisons.

7. A “hands-free” access device for accessing a motor vehicle, with said device being carried by a user and provided with a magnetometer and being able to communicate with the vehicle by radiofrequency communication, the access device being adapted to:
a) continuously measure an amplitude of the magnetic field and an orientation of said magnetic field;
b) send said measurements to the vehicle.

8. The “hands-free” access device for accessing a motor vehicle as claimed in claim 6, wherein said device comprises an accelerometer, said device is characterized in that it is able to:
a) continuously measure acceleration values;
b) correct the measurements of the magnetometer with the measurements of the accelerometer by scalar product;
c) compare the values of the scalar product with a predetermined scalar product profile;
d) activate the vehicle function according to the result of the comparison.

9. The “hands-free” access device for accessing a motor vehicle as claimed in claim 7, wherein said device comprises an accelerometer, said device is characterized in that it is able to:
a) continuously measure acceleration values;
b) send said measurements to the vehicle.

10. An activation device for activating a vehicle function, with the activation of the function being triggered by detecting the presence of a “hands-free” access device carried by a user in a predetermined zone around the vehicle or in a passenger compartment of the vehicle, and according to an authentication result of said device, with the activation device comprising at least one external antenna module for transmitting/receiving radiofrequencies and one internal antenna for transmitting/receiving radiofrequencies able to transmit in the passenger compartment of the vehicle, said device communicating with the “hands-free” access device, and being adapted to:
a) receive measurements of the amplitude of the magnetic field and of the orientation of the magnetic field originating from said device;
b) compare said measurements with predetermined amplitude and orientation profiles;
c) activate a vehicle function according to the result of the comparisons.

11. An activation device for activating a vehicle function, with the activation of the function being triggered by detecting the presence of a “hands-free” access device carried by a user in a predetermined zone around the vehicle or in a passenger compartment of the vehicle, and according to an authentication result of said device, with the activation device comprising at least one external antenna module for transmitting/receiving radiofrequencies and one internal antenna for transmitting/receiving radiofrequencies able to transmit in the passenger compartment of the vehicle, said device communicating with the “hands-free” access device, and being adapted to:
a) receive measurements of the amplitude of the magnetic field and of the orientation of the magnetic field and of acceleration originating from said device;
b) correct the values of the magnetometer with the values of the accelerometer by scalar product;
c) compare the values of the scalar product with a predetermined scalar product profile;
d) activate the vehicle function according to the result of said comparison.

12. A non-transitory computer program product comprising program code instructions for executing the steps of the method as claimed in claim 1 when said program is executed on a computer.

13. A motor vehicle, comprising an activation device as claimed in claim 10.
